(19) United States
(12) Patent Application Publication
(10) Pub. No.: US 2026/0166789 A1
(43) Pub. Date: Jun. 18, 2026

(54) METHOD OF MANUFACTURING AN INJECTION MOULD INSERT AND INJECTION MOULD INSERT

(71) Applicant: Hella GmbH & Co. KGaA, Lippstadt (DE)

(72) Inventor: Dietmar Haut, Lippstdt (DE)

(21) Appl. No.: 19/537,050

(22) Filed: Feb. 11, 2026

Related U.S. Application Data
(63) Continuation of application No. PCT/EP2023/074524, filed on Sep. 7, 2023.

(51) Int. Cl. B29C 45/14

(52) U.S. Cl. CPC B29C 45/14311

(57) ABSTRACT

A Method of manufacturing an injection mould insert is provided, especially for injection moulding of optical components of automotive lighting devices. An insert body is provided. A dedicated surface topography is formed into a surface of the insert body. The surface of the insert body is electroless plated by a nickel-dispersion coating comprising polytetrafluoroethylene particles dispersed in a nickel matrix.

### CROSS REFERENCE

This application claims priority to PCT Application No. PCT/EP2023/074524, filed Sep. 7, 2023, the entirety of which is hereby incorporated by reference.

### FIELD OF THE INVENTION

The present invention relates to a method of manufacturing an injection mould insert and to a corresponding injection mould insert for injection moulding of optical components of automotive lighting devices.

### BACKGROUND OF THE INVENTION

Optical components of automotive lighting devices are commonly manufactured by means of injection moulding, e.g., single lenses, micro-lens arrays, reflectors, diffusors, diffractive and holographic elements, anti-reflex structures, optical fibres, light guides, thickwall optics or cover lenses. A crucial property of such optical components is their surface condition, which significantly determines the functionality of the components in terms of light manipulation. Smooth surfaces are required, e.g., for highly efficient single lenses or reflectors, whereas a precise roughness level or dedicated surface patterns are mandatory for light diffusing elements or micro-lens arrays. The surface condition of the moulded optical components is directly determined by the surface condition of the respective moulds, which therefore has to meet high quality requirements. The mould is usually equipped with an insert featuring the desired surface topography to be moulded. Since optical components for automotive devices are typically mass products, the tool life of the mould inserts, and especially their surface condition, should be very long-lasting.

Two main problems occur when injection moulding optical components with microscale surface structures. Firstly, the injection-moulded components adhere to the surface structure of the mould insert, which makes demoulding more difficult or even causes distortion of the components during demoulding. In addition, impurities accumulate in the microscale structures on the surface of the inserts, in particular residues of auxiliary materials intended to facilitate demoulding, for example stearic acid. Such an accumulation of impurities increasingly deteriorates the surface quality of the moulded parts and requires regular cleaning intervals, which in industrial mass production are associated with undesirable production downtimes.

### BRIEF SUMMARY OF THE INVENTION

The object of the present invention is to provide an injection mould insert for the permanent and high-precision injection moulding of optical components of automotive lighting devices, and a method for its manufacture.

The invention discloses the technical teaching that the method of manufacturing the insert comprises at least the following steps: providing an insert body, forming a dedicated surface topography into a surface of the insert body, and electroless plating the surface of the insert body by a nickel-dispersion coating comprising polytetrafluoroethylene (PTFE) particles dispersed in a nickel matrix.

The invention makes use of the synergetic properties of the nickel-dispersion coating combining the high hardness, corrosion resistance and dimensional accuracy of electroless-nickel coatings with the anti-stick effect of the PTFE particles acting as embedded dry lubricant. The PTFE particles significantly reduce the adhesion of the moulded components and impurities. In particular, the use of further auxiliary materials intended to facilitate demoulding can be fully omitted in the injection moulding process. The use of the nickel dispersion coating on the injection mould insert thus facilitates the demoulding process and ensures a permanently contamination-free mould surface, so that significantly more uninterrupted production cycles can be run than was possible with the previously common state-of-the-art inserts.

Electroless nickel plating is an autocatalytic process, in which the reduction of nickel ions in a solution and the nickel coating deposition are carried out through the oxidation of a chemical compound present in the solution itself, i.e., a reducing agent like hydrated sodium hypophosphite, which supplies electrons. Unlike electroplating, it is not necessary to pass an electric current through the plating solution to form the nickel deposit. Electroless nickel plating creates homogeneous coatings regardless of the topography of the insert body surface and can even be applied to non-conductive surfaces depending on the catalyst. Electroless nickel coatings exhibit a very dense microstructure and are thus appropriate as corrosion protection for the mould body. The composition of electroless nickel coatings comprises apart from nickel typically also a certain amount of phosphorous. The co-deposition and incorporation of PTFE particles yields the nickel-dispersion coating with randomly distributed PTFE particles in nickel matrix and superior functionality for injection moulding purposes.

In particular, the surface of the insert is plated by a nickel-dispersion coating comprising an amount of 5 vol. % to 25 vol. % of PTFE particles, wherein the PTFE particles in particular feature diameter in the range of 0.5 μm to 5 μm. The PTFE particles typically exhibit spherical shapes.

Furthermore, the surface of the insert is plated by a nickel-dispersion coating with a thickness of 1 μm to 100 μm. The thickness depends on the detailed dimensions of the surface topography to be plated. Microscale topographies, e.g., for injection moulding diffuser optics or micro-lens arrays, require thin coatings to maintain spatial resolution of the surface topography, while thicker coatings are particularly useful for smoothing out unwanted surface roughness, e.g., for injection moulding mirror-bright reflector optics.

After plating the insert may be heat treated at a temperature of 200° C. to 300° C. for a period of 1 hour to 10 hours. Such heat treatment yields a significant hardening of the nickel-dispersion coating and thus improves its resistance against mechanical wear. Right after plating, the electroless nickel exhibits an amorphous microstructure, which is converted by the heat treatment into crystalline nickel and a hard nickel phosphide phase.

Preferably, the surface topography on the insert is formed by laser milling or mechanical machining, in particular to a spatial resolution in the range of 0.5 μm to 10 μm. Laser milling with pulsed laser sources, especially ultrashort pulses in the femtosecond range, is capable of patterning surfaces of various materials with lateral resolution well below 10 μm or in the case of periodic surface structures even with submicron resolution using multi-beam interference techniques. Laser milling is based on the physical process of laser ablation. i.e., sublimation of an irradiated material volume. Laser milling can be applied to mould bodies with complex three-dimensional surface contours.

Furthermore, the invention concerns an injection mould insert for injection moulding of optical components of automotive lighting devices, the insert being manufactured by one of the aforementioned embodiments of the inventive method, wherein the surface topography is in particular dedicated for injection moulding of a Fresnel optic, a micro-lens optic, a light-guide optic, a diffusor optic, or a reflector optic.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 illustrates the first step of an example embodiment of the inventive method.

FIG. 2 illustrates the second step of an example embodiment of the inventive method.

FIG. 3 illustrates the third step of an example embodiment of the inventive method, and of an inventive insert.

### DETAILED DESCRIPTION OF THE DRAWINGS

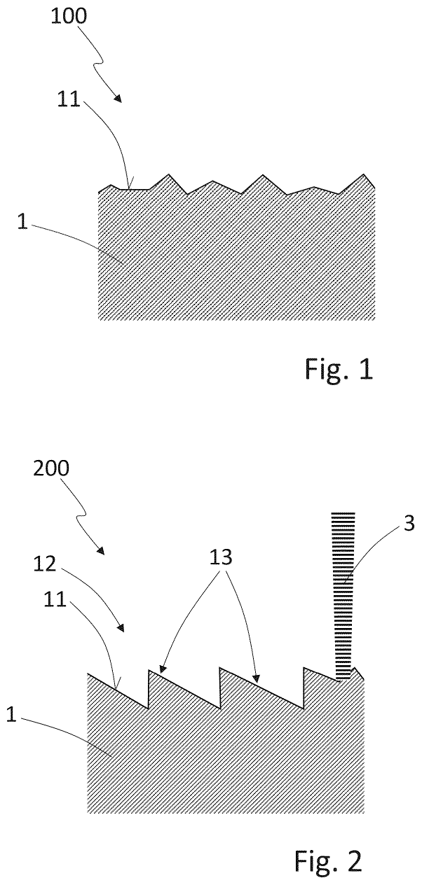

FIGS. 1-3 show schematic cross-sections of a segment of an insert body 1.

Providing 100 the insert body 1 is illustrated in FIG. 1 as the first step of the inventive method. The insert body 1 is advantageously machined from a tool steel by means of milling and/or electrical discharge machining. The surface 11 is oriented towards the cavity of the corresponding mould and thus has to be functionalized according to the inventive method in order to provide the desired surface quality of the components to be moulded. The topography of the surface 11 of the as-provided insert body 1 is determined by the machining process, namely the surface waviness and the different orders of surface roughness.

FIG. 2 illustrates the second step of the inventive method, namely forming 200 the dedicated surface topography 12 into the surface 11 of the insert body 1, in this case by means of laser milling. To this end, the laser beam 3 travels over the surface 11 along programmed trajectories and yields a local material ablation at a high spatial resolution, e.g., in the range of 1 μm to 10 μm. The laser beam 3 typically operates in pulsed mode, e.g., with femtosecond pulses. Advantageously, a multi-beam laser unit is applied for high surface ablation rates. The surface topography 12 in the example of FIG. 2 features the Fresnel rings 13, the insert thus being designed for injection moulding of Fresnel lenses for an automotive lighting device. Beyond the example illustrated here, laser milling is appropriate to generate a vast variety of pattern on complex three-dimensional mould body surfaces for various applications, e.g., micron-sized pattern for moulded parts with light-diffracting or light-diffusing properties or for holographic applications.

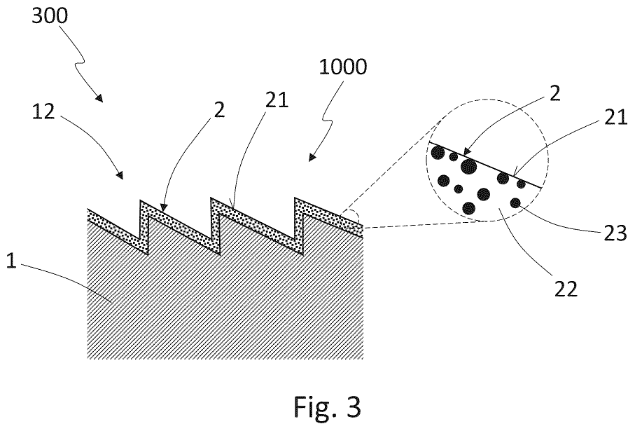

FIG. 3 illustrates the third step of the inventive method, namely electroless plating 300 the surface 11 of the insert body 1 by the nickel-dispersion coating 2 comprising PTFE particles 23 dispersed in a nickel matrix 22, finally yielding the inventive injection mould insert 1000. The dedicated surface topography 12 representing a Fresnel lens is well preserved by the nickel-dispersion coating 2, which is a merit of the electroless plating process. The magnified view of the nickel-dispersion coating 2 shows the PTFE particles 23 randomly distributed within the nickel matrix 22. At the coating surface 21 the PTFE particles 23 yield the desired anti-stick property, thus preventing the injection moulded components and impurity particles to adhere. When the injection mould insert 1000 wears upon service, the PTFE particles 23 initially embedded well below the coating surface 21 ensure proper functionality of the injection mould insert 1000 during its entire service lifetime.

The present invention is not limited by the embodiment described above, which is represented as an example only and can be modified in various ways within the scope of protection defined by the appending patent claims.

List of Numerals

| | |
|---|---|
| 1000 | insert |
| 1 | insert body |
| 11 | insert body surface |
| 12 | surface topography |
| 13 | Fresnel ring |
| 2 | coating |
| 21 | coating surface |
| 22 | nickel matrix |
| 23 | PTFE particle |
| 3 | laser beam |
| 100 | providing the insert body |
| 200 | forming the surface topography |
| 300 | plating |

1. A method of manufacturing an injection mould insert, the method comprising the steps of:
providing an insert body;
forming a dedicated surface topography into a surface of the insert body; and
electroless plating the surface of the insert body by a nickel-dispersion coating comprising polytetrafluoroethylene particles dispersed in a nickel matrix.

2. The method according to claim 1, wherein the surface is plated by a nickel-dispersion coating comprising an amount of 5 vol. % to 25 vol. % of polytetrafluoroethylene particles.

3. The method according to claim 1, wherein the surface is plated by a nickel-dispersion coating comprising polytetrafluoroethylene particles with a diameter of 0.5 μm to 5 μm.

4. The method according to claim 1, wherein the surface is plated by a nickel-dispersion coating with a thickness of 1 μm to 100 μm.

5. The method according to claim 1, wherein after plating, the insert is heat treated at a temperature of 200° C. to 300° C. for a period of 1 hour to 10 hours.

6. The method according to claim 1, wherein the surface topography is formed by laser milling or mechanical machining.

7. The method according to claim 1, wherein the surface topography is formed with a spatial resolution of 0.5 μm to 10 μm.

8. An injection mould insert for injection moulding of optical components of automotive lighting devices, wherein the mould is manufactured according to the following method:
providing an insert body;
forming a dedicated surface topography into a surface of the insert body; and
electroless plating the surface of the insert body by a nickel-dispersion coating comprising polytetrafluoroethylene particles dispersed in a nickel matrix.

9. The injection mould insert according to claim 8, wherein the surface topography is dedicated for injection moulding of a Fresnel optic, a micro-lens optic, a light-guide optic, a diffusor optic, or a reflector optic.
